(19) United States
(12) Patent Application Publication
(10) Pub. No.: US 2024/0356006 A1
(43) Pub. Date: Oct. 24, 2024

(54) METHOD FOR MANUFACTURING LITHIUM-ION BATTERY AND LITHIUM-ION BATTERY

(71) Applicant: TOYOTA JIDOSHA KABUSHIKI KAISHA, Toyota-shi (JP)

(72) Inventor: Daichi KOSAKA, Toyota-shi (JP)

(73) Assignee: TOYOTA JIDOSHA KABUSHIKI KAISHA, Toyota-shi (JP)

(21) Appl. No.: 18/425,599

(22) Filed: Jan. 29, 2024

(30) Foreign Application Priority Data
Apr. 21, 2023 (JP) 2023-070325

(51) Int. Cl. H01M 4/1391; H01M 4/02; H01M 4/04; H01M 4/131; H01M 4/40; H01M 4/525; H01M 4/62; H01M 10/0525; H01M 10/0585

(52) U.S. Cl. CPC H01M 4/1391; H01M 4/0445; H01M 4/131; H01M 4/405; H01M 4/525; H01M 4/623; H01M 10/0525; H01M 10/0585; H01M 2004/028

(57) ABSTRACT

A method for manufacturing a lithium-ion battery according to the present disclosure includes: providing a positive electrode precursor layer containing at least a lithium (Li) alloy with a Li alloying potential of 0.5 V (vsLi/Li⁺) or higher and a positive electrode active material; obtaining a lithium-ion battery precursor including the positive electrode precursor layer, a separator layer, and a negative electrode active material layer in this order and impregnated with an electrolyte solution; and performing initial charging of the lithium-ion battery precursor to change the positive electrode precursor layer to a positive electrode active material layer.

### CROSS-REFERENCE TO RELATED APPLICATION

This application claims priority to Japanese Patent Application No. 2023-070325 filed on Apr. 21, 2023, incorporated herein by reference in its entirety.

### BACKGROUND

### 1. Technical Field

The present disclosure relates to methods for manufacturing a lithium-ion battery and lithium-ion batteries.

### 2. Description of Related Art

Conventionally, active materials for lithium-ion batteries have been improved in order to increase the capacity.

Japanese Unexamined Patent Application Publication No. 2014-010991 (JP 2014-010991 A) discloses an electrode for use in a non-aqueous electrolyte secondary battery. The specific surface area of a negative electrode active material of this electrode as measured by the N₂ adsorption method is 3.3 m²/g or more and 4.4 m²/g or less. The dibutyl phthalate (DBP) oil absorption of a positive electrode active material of this electrode is 30 ml/100 g or more and 47 ml/100 g or less. The positive electrode density is 1.8 g/cm³ or higher and 2.2 g/cm³ or less. JP 2014-010991 A discloses increasing the capacity of the negative electrode by using a lithium (Li) alloy as an active material.

Lithium nickel cobalt manganese (NCM) oxide is widely used as a positive electrode active material, and an improvement in composition of the lithium NCM oxide has been studied. Specifically, JP 2014-010991 A discloses that the capacity of the positive electrode can be increased by increasing the ratio of nickel (Ni) in lithium NCM oxide as a positive electrode active material.

### SUMMARY

When conventional electrodes such as the electrode of JP 2014-010991 A are used, a significant decrease in capacity is sometimes observed after initial charging.

The present disclosure provides a novel method for manufacturing a lithium-ion battery and a novel lithium-ion battery that can reduce a decrease in capacity after initial charging.

The inventors of the present disclosure found through intensive studies that the above problem could be solved by the following means, and completed the present disclosure. The present disclosure is as follows.

### First Aspect

A method for manufacturing a lithium-ion battery includes: providing a positive electrode precursor layer containing at least a lithium alloy with a lithium alloying potential of 0.5 V (vsLi/Li⁺) or higher and a positive electrode active material; providing a lithium-ion battery precursor including the positive electrode precursor layer, a separator layer, and a negative electrode active material layer in this order and impregnated with an electrolyte; and performing initial charging of the lithium-ion battery precursor to change the positive electrode precursor layer to a positive electrode active material layer.

### Second Aspect

In the method according to the first aspect, the lithium-alloy may be selected from the group consisting of Li₃Bi, Li₃Sb, and NiSn.

### Third Aspect

In the method according to the first or second aspect, the positive electrode active material may be lithium NCM oxide.

### Fourth Aspect

A lithium-ion battery includes a positive electrode active material layer, a separator layer, and a negative electrode active material layer in this order. The positive electrode active material layer contains a positive electrode active material and either or both of bismuth as a simple substance and antimony as a simple substance.

According to the present disclosure, it is possible to provide a novel method for manufacturing a lithium-ion battery and a novel lithium-ion battery that can reduce a decrease in capacity after initial charging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a disclosed lithium-ion battery.

### DETAILED DESCRIPTION OF EMBODIMENTS

### Method for Manufacturing Lithium-Ion Battery

A method for manufacturing a lithium-ion battery according to the present disclosure includes: providing a positive electrode precursor layer containing at least a Li alloy with a lithium alloying potential (Li alloying potential) of 0.5 V (vsLi/Li⁺) or higher and a positive electrode active material; obtaining a lithium-ion battery precursor including the positive electrode precursor layer, a separator layer, and a negative electrode active material layer in this order and impregnated with an electrolyte; and performing initial charging of the lithium-ion battery precursor to change the positive electrode precursor layer to a positive electrode active material layer.

The inventors of the present disclosure found that the cause for the decrease in battery capacity described in JP 2014-010991 A was that Li supplied in the initial positive electrode active material was consumed in order to form a solid electrolyte interphase (SEI) in the negative electrode during the initial charging.

The inventors of the present disclosure found that the capacity can be increased by obtaining a lithium-ion battery using the above positive electrode precursor layer. Without wishing to be bound by theory, this is believed to be due to the fact that Li of Li alloy in the positive electrode precursor layers is released during the initial charge and becomes Li to be consumed by forming SEI in the negative electrode, which Li in the positive electrode active material can be suppressed from being consumed for forming SEI. Further, it is considered that when Li alloying potential of Li alloy is equal to or higher than 0.5 V (vsLi/Li⁺), it is possible to prevent an electrochemical reaction from occurring inside the positive electrode precursors prior to the initial charging.

Hereinafter, each component of the present disclosure will be described.

### Preparation of Positive Electrode Precursor Layer

The positive electrode precursor layer contains at least a Li alloy with a Li alloying potential of 0.5 V (vsLi/Li⁺) or higher, and a positive electrode active material. The positive electrode precursor layer may also contain other optional materials. Other materials include, for example, conductive auxiliaries and binders.

Preparation of the positive electrode precursor layer can be performed by mixing each material constituting this and coating.

### Li Alloy

Li alloy is a Li alloy having a Li alloying potential of 0.5 V (vsLi/Li⁺) or higher. The Li alloying potential may be 0.6 V (vsLi/Li⁺) or higher, 0.7 V (vsLi/Li⁺) or higher, or 0.8 V (vsLi/Li⁺), and may be 1.5 V (vsLi/Li⁺) or less, 1.4 V (vsLi/Li⁺) or less, 1.3 V (vsLi/Li⁺) or less, 1.2 V (vsLi/Li⁺) or less, 1.1 V (vsLi/Li⁺) or less, or 1.0 V (vsLi/Li⁺) or less.

The Li alloying potential (vsLi/Li⁺) is the electrode potential of the electrode response of Expression (1) and is expressed based on the electrode potential of lithium given by Expression (2).

$${x L i}^{+} + M + x {e}^{-} \text{←→} {Li}_{x} M \qquad ( 1 )$$

$${Li}^{+} + {e}^{-} \text{←→} Li \qquad ( 2 )$$

This Li alloying potential (vsLi/Li⁺) can be measured as the unipolar potential obtained when the alloy is immersed in Li saline solutions.

Examples of such a Li alloy include Li₃Bi, Li₃Sb, and NiSn.

### Positive Electrode Active Material

The positive electrode active material can be any positive electrode active material, and is not particularly limited. For example, a lithium-containing oxide can be used.

The lithium-containing oxide as the positive electrode active material is not particularly limited, and may include, for example, at least Li, at least one transition metal element selected from Co, Ni, and Mn, and O. As such a lithium-containing oxide, for example, lithium cobaltate (LiCoO₂), lithium nickelate (LiNiO₂), lithium manganate (LiMn₂O₄), and lithium nickel cobalt manganese (NCM) oxide in which part of these elements is replaced with other elements can be used. The lithium NCM oxide is generally represented by the general formula of LiₐMnₓNi_{y}CO_{z}O_{2±δ}(0<a≤1.5, 0≤x≤1.5, 0≤y≤1.5, 0<z≤1.5, 0<δ(=x+y+z)<1.5). The lithium-containing oxide as the positive electrode active material may have, for example, an O₂ type structure, an O₃ type structure, or a crystalline structure other than these. As the positive electrode active material, only one material may be used alone, or two or more materials may be used in combination.

### Conductive Aid

As the conductive auxiliary agent optionally contained in the positive electrode precursor layer, one known as a conductive auxiliary agent used in a lithium-ion battery may be used. Specifically, a carbon material such as Ketjen Black (KB), a vapor grown carbon fiber (VGCF), acetylene black (AB), carbon nanotubes (CNT), carbon nanofibers (CNF), carbon black, coke, graphite, or the like may be used. Alternatively, a metal material capable of withstanding the environment when the battery is used may also be used. As the conductive auxiliary agent, only one material may be used alone, or a combination of two or more materials may be used. The shape of the conductive aid may be various shapes such as powdery, fibrous, and the like. The amount of the conductive auxiliary agent contained in the positive electrode active material layer is not particularly limited.

### Binder

As the binder optionally contained in the positive electrode precursor layer, a binder known as a binder used in a lithium-ion battery may be used. For example, a styrene butadiene rubber (SBR)-based binder, a carboxymethyl cellulose (CMC)-based binder, an acrylonitrile butadiene rubber (ABR)-based binder, a butadiene rubber (BR)-based binder, a polyvinylidene fluoride (PVDF)-based binder, a polytetrafluoroethylene (PTFE)-based binder, and the like may be used. As the binder, only one material may be used alone, or a combination of two or more materials may be used. The amount of the binder contained in the positive electrode active material layer is not particularly limited.

### Preparation of Lithium-Ion Battery Precursor

The lithium-ion battery precursor has a positive electrode precursor layer, a separator layer, and a negative electrode active material layer in this order, and is impregnated with a non-aqueous electrolyte solution. The preparation of the lithium-ion battery precursor may be performed by a known method.

The lithium-ion battery precursor may further include a positive electrode current collector layer and a negative electrode current collector layer.

Hereinafter, each component of the lithium-ion battery precursor will be described.

### Positive Electrode Current Collector Layer

The positive electrode current collector layer may be formed of a known metal or the like that can be used as a positive electrode current collector of a lithium-ion battery. Examples of such metals include metal materials containing at least one element selected from the group consisting of Cu, Ni, Al, V, and Au, Pt, Mg, Fe, Ti, Pb, Co, Cr, Zn, Ge, In, Sn, and Zr. The form of the positive electrode current collector is not particularly limited. Various forms such as foil, mesh, porous, and the like may be employed. The metal may be deposited and plated on the surface of the substrate.

### Separator

As the separator, a separator known as a separator used in a lithium-ion battery may be used. For example, the separator may be made of a resin such as polyethylene (PE), polypropylene (PP), polyester, and polyamide. The separator may have a single-layer structure or a multi-layer structure. As the separator having a multilayer structure, for example, a separator having a multilayer structure composed of the above resins, a separator having a two-layer structure of PE/PP, a separator having a three-layer structure of PP/PE/PP or PE/PP/PE, etc. can be used. The separator may be composed of a nonwoven fabric such as a cellulose nonwoven fabric, a resin nonwoven fabric, or a glass fiber nonwoven fabric. The thickness of the separator is not particularly limited, and may be, for example, 5 μm or more and 1 mm or less.

### Negative Electrode Active Material Layer

The negative electrode active material layer contains a negative electrode active material. The negative electrode active material layer may contain other optional components. Examples of the other components include a conductive auxiliary agent and a binder. As the conductive assistant and the binder, reference can be made to the description of the positive electrode active material layer.

### Negative Electrode Active Material Layer: Negative Electrode Active Material

As the negative electrode active material, various materials having a potential (charge-discharge potential) at which ions are occluded and released, which is a lower potential than the positive electrode active material described above, may be used. As the negative electrode active material, for example, a silicon-based active material such as Si, a Si alloy, or silicon oxide; a carbon-based active material such as graphite, graphite, or hard carbon; various oxide-based active materials such as lithium titanate; and a metallic lithium or a lithium alloy may be used. As the negative electrode active material, only one material may be used alone, or two or more materials may be used in combination.

### Negative Electrode Current Collector Layer

The negative electrode current collector layer may be formed of a known metal or the like that can be used as a negative electrode current collector of a lithium-ion battery. Such a metal may be, for example, a metal material containing at least one element selected from the group consisting of Cu, Ni, Al, V, and Au, Pt, Mg, Fe, Ti, Pb, Co, Cr, Zn, Ge, In, Sn, and Zr. The form of the negative electrode current collector layer is not particularly limited, and may be various forms such as a foil form, a mesh form, and a porous form. The negative electrode current collector layer may be formed by plating or depositing the metal on the surface of a substrate made of an optional material. The surface of the negative electrode current collector layer may be coated with a carbon material or the like.

### Non-Aqueous Electrolyte

The non-aqueous electrolyte may contain a non-aqueous solvent and an electrolyte. The electrolytic solution may contain an alkali metal ion as a carrier ion, for example, a lithium ion.

As the non-aqueous solvent, a solvent other than water, for example, an organic solvent can be used. As the organic solvent, for example, a carbonate-based solvent such as ethylene carbonate (EC), dimethyl carbonate (DMC), ethyl methyl carbonate (EMC), or fluoroethylene carbonate (FEC) can be used. These organic solvents may be used singly or in combination.

The electrolyte is not particularly limited, and may be, for example, a lithium salt. For example, LiPF₆ can be used.

### Preparation of Positive Electrode Active Material Layer

Preparation of the positive electrode active material layer is performed by performing initial charging on the lithium-ion battery precursor and forming the positive electrode precursor layer into the positive electrode active material layer.

When initial charging of the lithium-ion battery precursor having the positive electrode layer precursor layer is performed, Li of the Li alloy is consumed in order to form an SEI in the negative electrode. As a result, when the Li alloy contains either or both of Li₃Bi and Li₃Sb, the resulting positive electrode active material layer contains either or both of bismuth as a simple substance and antimony as a simple substance.

The initial charging condition may be a known condition.

### Lithium-Ion Battery

The lithium-ion battery of the present disclosure includes a positive electrode active material layer, a separator layer, and a negative electrode active material layer. The positive electrode active material layer contains a positive electrode active material and either or both of bismuth as a simple substance and antimony as a simple substance.

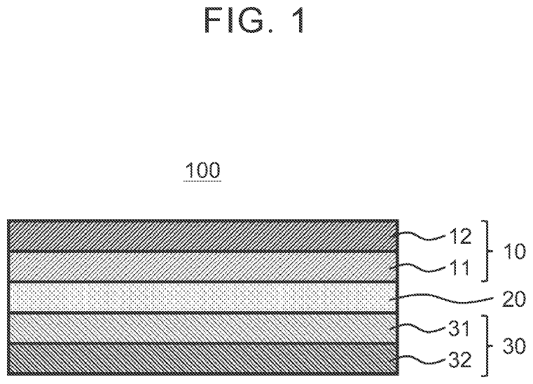

FIG. 1 schematically illustrates a configuration of a lithium-ion battery 100 according to one embodiment of the present disclosure. As illustrated in FIG. 1, the lithium-ion battery 100 may include a positive electrode 10, a separator 20, and a negative electrode 30. The positive electrode 10 may include the positive electrode active material layer 11 and the positive electrode current collector layer 12, and the negative electrode 30 may include the negative electrode active material layer 31 and the negative electrode current collector layer 32. In this case, the positive electrode active material layer 11 may include the above-described positive electrode active material. The electrolyte may be included in the positive electrode active material layer 11 and the negative electrode active material layer 31, although not shown.

For each configuration of the lithium-ion battery, the description of the manufacturing method can be referred to.

The present disclosure will be described in detail with reference to Examples and Comparative Examples, but the present disclosure is not limited thereto.

### Preparation of Lithium-Ion Battery.

### Example 1

92.3 mg of LiNi_{0.8}Co_{0.1}Mn_{0.1}O₂, as a positive electrode active material, 8.4 mg of Li₃Bi as a Li-alloy, a conductive aid, and a binder were mixed in an NMP to form a slurry. This slurry was applied to an Al foil and dried to obtain a positive electrode precursor layer.

The obtained positive electrode precursor layer was placed to face a negative electrode active material layer containing graphite as an active material with a separator layer therebetween, vacuum-dried, and a non-aqueous electrolyte solution was introduced to obtain a lithium-ion battery precursor.

### Examples 2, 3 and Comparative Examples 1 to 3

The lithium-ion battery precursors of Examples 2 to 3 and Comparative Examples 1 to 3 were obtained in the same manner as in Example 1, except that the content of the positive electrode active material and the type and content of Li alloy were changed as shown in Table 1.

### Evaluation

The mass of the positive electrode active material contained in the cell is used as a reference, the current value that becomes 210 mA/g is defined as 1 C rate, 0.2 C is set as the charge/discharge current value, 0.03 C is set as the termination current value, and CCCV charge and CCCV discharge are performed. The upper limit voltage at the time of charge is 4.25 V, and the lower limit voltage at the time of discharge is 2.50 V. The obtained CCCV discharging capacity is defined as the capacity of the cell, and is used as an evaluation index of the present disclosure.

The configurations and evaluation results of the examples and comparative examples are shown in Table 1.

TABLE 1

| | Configuration | | | | | | | | | | | |
|---|---|---|---|---|---|---|---|---|---|---|---|---|
| | | | | | | | | | | Positive | | |
| | Positive Electrode | | | | Li Alloy | | | | | Electrode | Evaluation Results | |
| | Active Material | | | | | | Li | | | Active | Battery Capacity | |
| | | Amount of | | | | Amount of | Alloying | | | Material | (First Charging/ | |
| | | Released | Con- | | | Released | Potential | Con- | | Layer | Discharging) | |
| | | Li | tent | Volume | | Li | (V(vs | tent | Volume | Volume | Charging | Discharging |
| | Type | (mol-Li/cc) | (mg) | (cc) | Type | (mol-Li/cc) | Li/Li*)) | (mg) | (cc) | (cc) | (mAh) | (mAh) |
| Example 1 | NCM811 | 0.047 | 92.3 | 0.0200 | Li₃Bi | 0.065 | 0.81 to 0.83 | 8.4 | 0.0017 | 0.0217 | 25.0 | 22.1 |
| Example 2 | NCM811 | 0.047 | 92.8 | 0.0202 | Li₃Sb | 0.070 | 0.94 to 0.96 | 5.2 | 0.0015 | 0.0217 | 25.1 | 22.3 |
| Example 3 | NCM811 | 0.047 | 87.3 | 0.0190 | LiSn | 0.040 | 0.57 to 0.66 | 13.8 | 0.0027 | 0.0217 | 24.0 | 21.0 |
| Comparative | NCM811 | 0.047 | 92.4 | 0.0201 | Li_{2.6}Sn | 0.066 | 0.48 | 5.8 | 0.0016 | 0.0217 | 24.3 | 20.9 |
| Example 1 | | | | | | | | | | | | |
| Comparative | NCM811 | 0.047 | 93.3 | 0.0203 | Li_{4.4}Sn | 0.076 | 0.38 | 3.7 | 0.0014 | 0.0217 | 20.0 | 17.4 |
| Example 2 | | | | | | | | | | | | |
| Comparative | NCM811 | 0.047 | 100.0 | 0.0217 | | | | | | 0.0217 | 23.9 | 20.7 |
| Example 3 | | | | | | | | | | | | |

The results in Table 1 show that the lithium-ion battery of the present disclosure obtained from the Li alloy with a Li alloying potential of 0.5 V (vsLi/Li⁺) or higher and the positive electrode active material can reduce a decrease in capacity of the positive electrode.

What is claimed is:

1. A method for manufacturing a lithium-ion battery, the method comprising:
providing a positive electrode precursor layer containing at least a lithium alloy with a lithium alloying potential of 0.5 V (vsLi/Li⁺) or higher and a positive electrode active material;
providing a lithium-ion battery precursor including the positive electrode precursor layer, a separator layer, and a negative electrode active material layer in this order and impregnated with an electrolyte; and
performing initial charging of the lithium-ion battery precursor to change the positive electrode precursor layer to a positive electrode active material layer.

2. The method according to claim 1, wherein the lithium alloy is selected from the group consisting of Li₃Bi, Li₃Sb, and NiSn.

3. The method according to claim 1, wherein the positive electrode active material is lithium nickel cobalt manganese oxide.

4. A lithium-ion battery comprising a positive electrode active material layer, a separator layer, and a negative electrode active material layer in this order, wherein the positive electrode active material layer contains a positive electrode active material and either or both of bismuth as a simple substance and antimony as a simple substance.
